(19) United States
(12) Patent Application Publication
(10) Pub. No.: US 2025/0158275 A1
(43) Pub. Date: May 15, 2025

(54) ANTENNA MODULE

(71) Applicant: Fujikura Ltd., Tokyo (JP)

(72) Inventor: Yasuo Nakanishi, Sakura-shi (JP)

(73) Assignee: Fujikura Ltd., Tokyo (JP)

(21) Appl. No.: 18/936,327

(22) Filed: Nov. 4, 2024

(30) Foreign Application Priority Data
Nov. 9, 2023 (JP) 2023-191547

(51) Int. Cl. H01Q 1/52; H01Q 3/26

(52) U.S. Cl. CPC H01Q 1/526; H01Q 3/2605

(57) ABSTRACT

An antenna module includes a first substrate that includes a first antenna element and a feeding line to a second antenna element and configured to handle a high-frequency signal in a millimeter wave band, a second substrate arranged to overlap a portion of the first substrate in plan view and configured to handle a baseband signal having a frequency band lower than that of the high-frequency signal, and a metal housing that includes a first accommodation space configured to accommodate a RFIC, a second accommodation space configured to accommodate a BBIC, and a shielding wall provided between the first accommodation space and the second accommodation space, the shielding wall is arranged to overlap the feeding line in plan view, and at least one of the shielding wall and the first substrate includes a non-interference portion configured to reduce interference between the shielding wall and the feeding line.

### CROSS-REFERENCE TO RELATED APPLICATION

Priority is claimed on Japanese Patent Application No. 2023-191547 filed Nov. 9, 2023, the content of which is incorporated herein by reference.

### BACKGROUND OF THE INVENTION

### Field of the Invention

The present invention relates to an antenna module.

### Description of Related Art

Japanese Patent No. 7309089 discloses a wireless module that transmits and receives a high-frequency signal (RF signal). The wireless module includes a first substrate that handles a high-frequency signal in a millimeter wave band, a second substrate that handles a baseband signal with a frequency lower than that of the high-frequency signal, and a housing that accommodates the first substrate and the second substrate. The first substrate and the second substrate partially overlap each other and are connected to each other, which reduces the module size in a planar direction.

### SUMMARY OF THE INVENTION

A radio-frequency integrated circuit (RFIC) that processes a high-frequency signal is provided on a first substrate, and a baseband integrated circuit (BBIC) that processes a baseband signal is provided on a second substrate. Since the RFIC and the BBIC interfere with each other electromagnetically when the circuits are close to each other, a partitioning portion (shielding wall) is provided in the housing.

In an array antenna, feeding lines from the RFIC to each antenna need to have the same length. Therefore, the RFIC is often positioned at the center of the first substrate in plan view. Therefore, feeding lines extending toward the second substrate are present on a typical first substrate.

In such a configuration, in order to further reduce the size of the module, when the overlap amount between the first substrate and the second substrate is increased, the feeding lines extending from the RFIC toward the second substrate and the partitioning portion may overlap each other in plan view. In this case, there is a concern that the partitioning portion may come close to the feeding line and adversely affect the feeding line, causing deterioration in the antenna characteristics.

The present invention has been made in view of the above-described problems, and an object thereof is to provide an antenna module capable of achieving a reduced module size in a planar direction while suppressing deterioration in antenna characteristics.

According to a first aspect of the present invention, an antenna module is provided, including: a first substrate that includes an antenna element and a feeding line to the antenna element and configured to handle a high-frequency signal in a millimeter wave band; a second substrate arranged to overlap a portion of the first substrate in plan view, and configured to be electrically connected to the first substrate at the overlapped portion and handle a baseband signal having a frequency band lower than that of the high-frequency signal; and a metal housing to which the first substrate and the second substrate are attached, in which the first substrate is provided with a first IC configured to process the high-frequency signal and be electrically connected to the feeding line on a first mounting surface facing the metal housing, the second substrate is provided with a second IC configured to process the baseband signal on a second mounting surface facing the metal housing, the metal housing includes a first accommodation space configured to accommodate the first IC, a second accommodation space configured to accommodate the second IC, and a shielding wall provided between the first accommodation space and the second accommodation space, the shielding wall is arranged to overlap the feeding line in plan view, and at least one of the shielding wall and the first substrate includes a non-interference portion configured to reduce interference between the shielding wall and the feeding line.

According to the first aspect of the present invention, since the first substrate and the second substrate partially overlap each other and are connected to each other, the module size in the planar direction can be reduced. Since the shielding wall of the metal housing is provided between the first IC mounted on the first substrate and the second IC mounted on the second substrate, electromagnetic interference between the first IC and the second IC can be avoided. Unwanted emission from the first IC and the second IC can be prevented from leaking to the outside. Further, since the non-interference portion that reduces the interference between the shielding wall and the feeding line is provided in at least one of the shielding wall and the first substrate even when the shielding wall is arranged to overlap the feeding line of the first substrate in plan view, the presence of the shielding wall is less likely to adversely affect the feeding line, and deterioration in the antenna characteristics can be suppressed.

In a second aspect of the present invention, in the antenna module according to the first aspect, the shielding wall may include a contact surface configured to come into contact with the first mounting surface, and a tunnel portion formed on the contact surface and configured to extend along the feeding line, and the tunnel portion may form the non-interference portion.

In a third aspect of the present invention, in the antenna module according to the second aspect, the tunnel portion may have a semicircular cross section, and a diameter of the cross section of the tunnel portion may be larger than the width of the feeding line.

In a fourth aspect of the present invention, in the antenna module according to the third aspect, the diameter of the tunnel portion may be more than three times larger than the width of the feeding line.

In a fifth aspect of the present invention, in the antenna module according to either the third aspect or the fourth aspect, the diameter of the tunnel portion may be smaller than 1/10 of a wavelength of unwanted emission.

In a sixth aspect of the present invention, in the antenna module according to any one of the first to fifth aspects, the first substrate may include a ground layer on a first mounting surface side with respect to the feeding line, and the ground layer may form the non-interference portion.

According to one aspect of the present invention, it is possible to provide an antenna module capable of achieving a reduced module size in a planar direction while suppressing deterioration in antenna characteristics.

### BRIEF DESCRIPTION OF THE DRAWINGS

FIG. 1 is a cross-sectional configuration view of an antenna module according to a first embodiment.

FIG. 2 is an enlarged view of a region A shown in FIG. 1.

FIG. 3 is a bottom side perspective view of a region B shown in FIG. 1.

FIG. 4 is a cross-sectional view of a main part of an antenna module according to a second embodiment.

### DETAILED DESCRIPTION OF THE INVENTION

Hereinafter, an antenna module according to each embodiment of the present invention will be described with reference to the accompanying drawings.

### First Embodiment

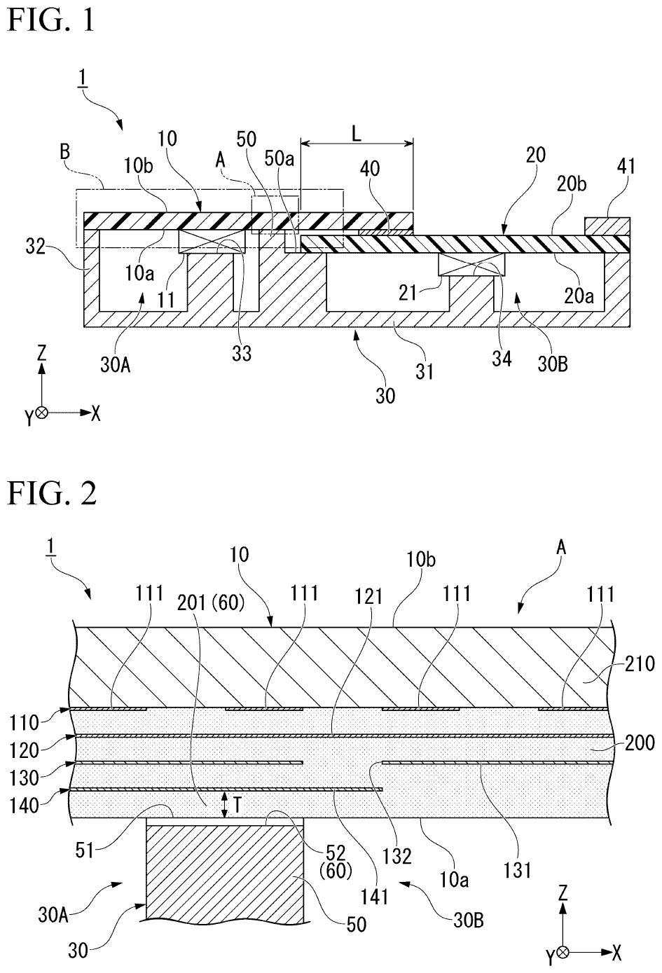

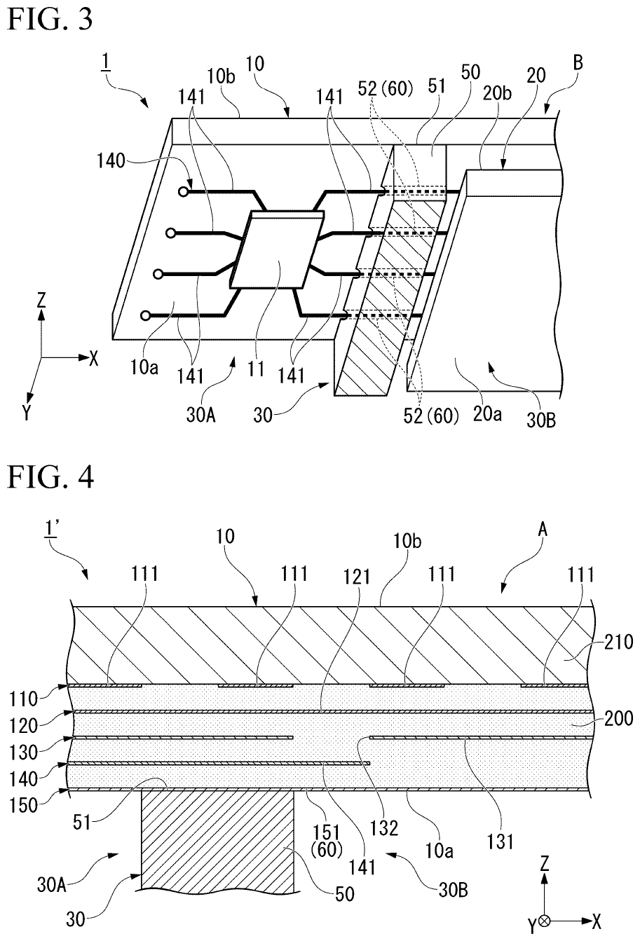

FIG. 1 is a cross-sectional configuration diagram of an antenna module 1 according to a first embodiment. FIG. 2 is an enlarged view of a region A shown in FIG. 1. FIG. 3 is a bottom side perspective view of a region B shown in FIG. 1.

As shown in FIG. 1, the antenna module 1 according to the present embodiment includes a first substrate 10, a second substrate 20, and a metal housing 30.

The first substrate 10 is formed in a rectangular plate-like shape in plan view. The first substrate 10 handles a high-frequency signal (RF signal) in a millimeter wave band. In addition, the second substrate 20 is formed in a rectangular plate-like shape in plan view. The second substrate 20 handles a baseband signal (BB signal) in a frequency band lower than that of the high-frequency signal. The first substrate 10 and the second substrate 20 are attached to the metal housing 30 in a state in which the first substrate and the second substrate partially overlap each other in plan view.

In the following description, an XYZ orthogonal coordinate system is set up and the positional relationship of each member will be described with reference to the XYZ orthogonal coordinate system. As shown in FIG. 1, a Z-axis direction is set in plan view direction in which the first substrate 10 and the second substrate 20 overlap each other. An X-axis direction and a Y-axis direction are set in the planar direction along the plate surface of the first substrate 10 and the second substrate 20.

Hereinafter, for convenience of description, in the Z-axis direction, the first substrate 10 (+Z side) side with respect to the second substrate 20 is referred to as an upper side, and the metal housing 30 side with respect to the second substrate 20 is referred to as a lower side (−Z side). In addition, it is not necessary that the upper side in a gravity direction be the first substrate 10 nor that the lower side in the gravity direction be the metal housing 30.

The first substrate 10 is provided with an RFIC 11 (first IC) on a lower surface 10a (first mounting surface) facing the metal housing 30. In addition, the first substrate 10 is provided with an inter-substrate connection portion 40 on the lower surface 10a. In addition, other electronic components (not shown) may be provided on an upper surface 10b of the first substrate 10. The RFIC 11 generates a predetermined high-frequency signal from, for example, a baseband signal supplied from the second substrate 20. In addition, the first substrate 10 performs not only a reception process of a high-frequency signal but also a transmission process.

The first substrate 10 is a multilayer substrate having a plurality of conductor layers as shown in FIG. 2. Specifically, the first substrate 10 includes conductor layers arranged in the order of a first layer 110, a second layer 120, a third layer 130, and a fourth layer 140 from the upper side toward the lower side. An insulator 200, such as a liquid crystal polymer, is provided between the first layer 110, the second layer 120, the third layer 130, and the fourth layer 140.

The first layer 110 is a first antenna layer, and a plurality of first antenna elements 111 (parasitic elements) are formed. The first antenna elements 111 are arranged in an array. The second layer 120 is a second antenna layer, and a second antenna element 121 (feeding element) to be arranged on the lower side of the first antenna element 111 is formed. The first antenna element 111 and the second antenna element 121 function as antennas.

The third layer 130 forms a ground layer 131 that is electrically grounded. An opening portion 132 is formed in the ground layer 131. The fourth layer 140 is a signal layer, and a feeding line 141 is formed. The feeding line 141 is electromagnetically coupled (for example, capacitively coupled) to the second antenna element 121 through the opening portion 132 of the third layer 130. By the coupling, the first substrate 10 can radiate the high-frequency signal, supplied from the feeding line 141, from the second antenna element 121 and the first antenna element 111, or can output the high-frequency signal, received by the second antenna element 121 and the first antenna element 111, to the feeding line 141.

It should be noted that the form of the antenna is not limited to this form, and the form may be one in which the feeding line 141 and the second antenna element 121 are electrically and physically connected to each other, or a form in which the first antenna element 111 (parasitic element) is not provided.

The feeding line 141 is provided in the inner layer of the first substrate 10. That is, the feeding line 141 is not exposed on the lower surface 10a of the first substrate 10, and the lower side of the feeding line 141 is covered with the insulator 200. On the other hand, the first layer 110 (first antenna element 111) is covered with a protective film 210. The protective film 210 may be a low loss dielectric that does not adversely affect the transmission and reception of a high-frequency signal. In addition, the protective film 210 may have a function of improving the gain of a high-frequency signal.

Returning to FIG. 1, the second substrate 20 is provided with a BBIC 21 (second IC) on a lower surface 20a (second mounting surface) facing the metal housing 30. Further, in addition to the inter-substrate connection portion 40 and an external connection portion 41, other electronic components (not shown) are provided on an upper surface 20b of the second substrate 20. For example, the BBIC 21 is connected to an external device (not shown) through the external connection portion 41 and generates a predetermined baseband signal based on a command from the external device.

The inter-substrate connection portion 40 is arranged in an overlap region L in which the first substrate 10 and the second substrate 20 overlap each other in plan view. The inter-substrate connection portion 40 is a connector that mechanically and electrically connects the first substrate 10 and the second substrate 20 in the Z-axis direction. The inter-substrate connection portion 40 connects a +X side end portion of the lower surface 10a of the first substrate 10 and a portion closer to the center portion (BBIC 21) than to a −X side end portion of the upper surface 20b of the second substrate 20.

As shown in FIG. 1, since the first substrate 10 and the second substrate 20 partially overlap each other and are connected to each other, the module size in the planar direction (for example, X-axis direction) can be reduced. No electronic components other than the inter-substrate connection portion 40 may be arranged between the first substrate 10 and the second substrate 20 in the overlap region L, specifically, on the lower surface 10a of the first substrate 10 and the upper surface 20b of the second substrate 20 in the overlap region L. In this way, a gap between the first substrate 10 and the second substrate 20 can be reduced, and the module size in the plan view direction (Z-axis direction) can be reduced.

As shown in FIG. 1, the metal housing 30 includes a bottom wall 31, a peripheral wall 32, and a shielding wall 50. The bottom wall 31 has a rectangular shape in plan view, extending in the X-axis direction and the Y-axis direction. The peripheral wall 32 has a rectangular frame shape in plan view along an outer peripheral edge of the bottom wall 31. The peripheral wall 32 extends toward the upper side (toward the +Z side) from the outer peripheral edge of the bottom wall 31. The outer peripheral edges of the first substrate 10 and the second substrate 20 are partially attached to an upper end portion of the peripheral wall 32.

The shielding wall 50 forms a first accommodation space 30A that accommodates the RFIC 11 and a second accommodation space 30B that accommodates the BBIC 21 on the inner side of the bottom wall 31 and the peripheral wall 32. The shielding wall 50 extends in the Y-axis direction between the RFIC 11 and the BBIC 21, and is connected to each of the inner walls of the peripheral wall 32 facing each other in the Y-axis direction. In addition, the shielding wall 50 extends from the bottom wall 31 toward the upper side (+Z side). A step surface 50a that supports the lower surface 20a of the second substrate 20 is formed in an upper end portion of the shielding wall 50.

A first heat dissipation portion 33 is formed in the first accommodation space 30A. The first heat dissipation portion 33 extends from the bottom wall 31 toward the upper side (+Z side) and is in contact with the RFIC 11 through a heat dissipation sheet (not shown). In addition, a second heat dissipation portion 34 is formed in the second accommodation space 30B. The second heat dissipation portion 34 extends from the bottom wall 31 toward the upper side (+Z side) and is in contact with the BBIC 21 through a heat dissipation sheet (not shown).

As shown in FIG. 2, a contact surface 51 that comes into contact with the lower surface 10a of the first substrate 10 is formed in the upper end portion of the shielding wall 50. A tunnel portion 52 that extends in the X-axis direction along the feeding line 141 is formed on the contact surface 51. The tunnel portion 52 forms anon-interference portion 60 that reduces the interference between the shielding wall 50 and the feeding line 141. It should be noted that the interference referred to herein is interference that can affect the antenna characteristics of the antenna module 1, and includes some or all of electrical, electromagnetic, and mechanical interference.

As shown in FIG. 3, a plurality of the feeding lines 141 are connected to the RFIC 11. The feeding line 141 extending from the RFIC 11 toward the second substrate 20 side (+X side) overlaps the shielding wall 50 in plan view. Therefore, the tunnel portion 52 (non-interference portion 60) is formed in the shielding wall 50.

The tunnel portion 52 is formed in a semicircular shape in a transverse cross section along the Y-Z plane. The diameter of the tunnel portion 52 is larger than the width of the feeding line 141. Preferably, the diameter of the tunnel portion 52 is more than three times larger than the width of the feeding line 141. In addition, the diameter of the tunnel portion 52 is preferably smaller than 1/10 of the wavelength of unwanted emission.

That is, when the diameter of the tunnel portion 52 is denoted by D, the width of the feeding line 141 is denoted by W, and the wavelength of unwanted emission is denoted by λ, it is desirable that the following relational expression (1) be satisfied.

$$3 W < D < λ / 10 \qquad ( 1 )$$

As an example, in a case in which the frequency of the source signal of the RFIC 11 is 20 GHz, λ= 1/20 GHz=15 mm. In a case of W=0.2 mm, D is 0.6 mm or more and 1.5 mm or less.

When a thickness T of the insulator 200 on the lower side of the feeding line 141 shown in FIG. 2 is sufficiently thick, the tunnel portion 52 may not be provided, and the interference between the shielding wall 50 and the feeding line 141 can be reduced. In this case, in the insulator 200, an insulator 201 on the lower side of the feeding line 141 becomes the non-interference portion 60. In addition, even when the thickness T is zero, the interference between the shielding wall 50 and the feeding line 141 can be reduced by forming the aforementioned tunnel portion 52 and satisfying the relational expression (1).

As described above, the antenna module 1 according to the present embodiment includes the first substrate 10 that includes the second antenna element 121 and the feeding line 141 to the second antenna element 121 and is configured to handle a high-frequency signal in the millimeter wave band, the second substrate 20 arranged to overlap a portion of the first substrate 10 in plan view, and configured to be electrically connected to the first substrate 10 at the overlapped portion and handle the baseband signal in the frequency band lower than that of the high-frequency signal, and the metal housing 30 to which the first substrate 10 and the second substrate 20 are attached, the first substrate 10 is provided with the RFIC 11 configured to process the high-frequency signal and is electrically connected to the feeding line 141 on the lower surface 10a facing the metal housing 30, the second substrate 20 is provided with the BBIC 21 configured to process the baseband signal on the lower surface 20a facing the metal housing 30, the metal housing 30 includes the first accommodation space 30A configured to accommodate the RFIC 11, the second accommodation space 30B configured to accommodate the BBIC 21, and the shielding wall 50 provided between the first accommodation space 30A and the second accommodation space 30B, the shielding wall 50 is arranged to overlap the feeding line 141 in plan view, and at least one of the shielding wall 50 and the first substrate 10 includes the non-interference portion 60 configured to reduce interference between the shielding wall 50 and the feeding line 141.

With this configuration, since the first substrate 10 and the second substrate 20 partially overlap each other and are connected to each other, the module size in the planar direction can be reduced. In addition, since the shielding wall 50 of the metal housing 30 is provided between the RFIC 11 mounted on the first substrate 10 and the BBIC 21 mounted on the second substrate 20, electromagnetic interference between the RFIC 11 and the BBIC 21 can be avoided. In addition, unwanted emission from the RFIC 11 and the BBIC 21 can be prevented from leaking to the outside. Further, since the non-interference portion 60 that reduces the interference between the shielding wall 50 and the feeding line 141 is provided in at least one of the shielding wall 50 and the first substrate 10, even when the shielding wall 50 is arranged to overlap the feeding line 141 of the first substrate 10 in plan view, the presence of the shielding wall 50 is less likely to adversely affect the feeding line 141, and deterioration in the antenna characteristics can be suppressed.

In addition, in the present embodiment, the shielding wall 50 includes the contact surface 51 that comes into contact with the lower surface 10a of the first substrate 10, and the tunnel portion 52 formed on the contact surface 51 and extending along the feeding line 141, and the tunnel portion 52 forms the non-interference portion 60. With this configuration, even in a case where the thickness T of the insulator 200 cannot be sufficiently secured on the lower side of the feeding line 141, deterioration in the antenna characteristics can be suppressed by forming the tunnel portion 52.

In addition, in the present embodiment, the tunnel portion 52 has a semicircular cross section and the diameter of the cross section of the tunnel portion 52 is larger than the width of the feeding line 141. With this configuration, the shielding wall 50 (the inner wall of the tunnel portion 52) can be prevented from coming into contact with the feeding line 141.

In addition, in the present embodiment, the diameter of the tunnel portion 52 is more than three times larger than the width of the feeding line 141. With this configuration, since a sufficient space can be secured on both sides of the feeding line 141 in the width direction, deterioration in the antenna characteristics can be suppressed.

In addition, in the present embodiment, the diameter of the tunnel portion 52 is smaller than 1/10 of the wavelength of the unwanted emission. With this configuration, signals having unwanted emission wavelength can be shielded.

### Second Embodiment

Next, a second embodiment of the present invention will be described. In the following description, the same or equivalent configurations as those in the above-described embodiment are designated by the same reference signs, and descriptions thereof will be simplified or omitted.

FIG. 4 is a cross-sectional view of a main part of an antenna module 1′ according to a second embodiment. In addition, FIG. 4 shows a portion corresponding to that shown in FIG. 2. As shown in FIG. 4, the antenna module 1′ of the second embodiment differs from the above-described embodiment in that the first substrate 10 includes a ground layer 151 on the lower surface 10a side (the lower surface 10a in the present embodiment) with respect to the feeding line 141, and the ground layer 151 forms the non-interference portion 60.

The first substrate 10 according to the second embodiment includes a conductor layer of a fifth layer 150, in addition to the conductor layers of the first layer 110, the second layer 120, the third layer 130, and the fourth layer 140. The fifth layer 150 is arranged on the lower side (−Z side) of the fourth layer 140, and the insulator 200 is provided between the fourth layer 140 and the fifth layer 150. In addition, the fifth layer 150 shown in FIG. 4 is exposed on the lower surface 10a of the first substrate 10, but may be covered with the insulator 200.

The fifth layer 150 has the ground layer 151 that is electrically grounded. The ground layer 151 may have a so-called solid pattern in which the opening portion 132 is not formed, unlike the ground layer 131 of the third layer 130. With this configuration, since the ground layer 151 arranged between the shielding wall 50 and the feeding line 141 secures isolation between the shielding wall 50 and the feeding line 141, deterioration in the antenna characteristics can be suppressed.

While preferred embodiments of the present invention have been described and illustrated above, it should be understood that these are exemplary of the present invention and should not be considered as limiting. Additions, omissions, substitutions, and other modifications can be made without departing from the scope of the present invention. Accordingly, the present invention should not be considered as being limited by the foregoing description and is only limited by the scope of the appended claims.

Although the tunnel portion 52 has been described above using a semicircular cross section as an example, the tunnel portion 52 may have a rectangular cross section.

In addition, it is possible to appropriately replace the constituent elements in the above-described embodiment with well-known constituent elements and the above-described embodiments and modification examples may be appropriately combined without departing from the scope of the present invention.

What is claimed is:

1. An antenna module comprising:
a first substrate that includes an antenna element and a feeding line to the antenna element and configured to handle a high-frequency signal in a millimeter wave band;
a second substrate arranged to overlap a portion of the first substrate in plan view, and configured to be electrically connected to the first substrate at the overlapped portion and handle a baseband signal having a frequency band lower than that of the high-frequency signal; and
a metal housing to which the first substrate and the second substrate are attached,
wherein the first substrate is provided with a first IC configured to process the high-frequency signal and be electrically connected to the feeding line on a first mounting surface facing the metal housing,
the second substrate is provided with a second IC configured to process the baseband signal on a second mounting surface facing the metal housing,
the metal housing includes
a first accommodation space configured to accommodate the first IC,
a second accommodation space configured to accommodate the second IC, and
a shielding wall provided between the first accommodation space and the second accommodation space,
the shielding wall is arranged to overlap the feeding line in plan view, and
at least one of the shielding wall and the first substrate includes a non-interference portion configured to reduce interference between the shielding wall and the feeding line.

2. The antenna module according to claim 1,
wherein the shielding wall includes
a contact surface configured to come into contact with the first mounting surface, and
a tunnel portion formed on the contact surface and configured to extend along the feeding line, and
the tunnel portion forms the non-interference portion.

3. The antenna module according to claim 2,
wherein the tunnel portion has a semicircular cross section, and a diameter of the cross section of the tunnel portion is larger than the width of the feeding line.

4. The antenna module according to claim 3,
wherein the diameter of the tunnel portion is more than three times larger than the width of the feeding line.

5. The antenna module according to claim 3,
wherein the diameter of the tunnel portion is smaller than 1/10 of a wavelength of unwanted emission.

6. The antenna module according to claim 1,
wherein the first substrate includes a ground layer on a first mounting surface side with respect to the feeding line, and
the ground layer forms the non-interference portion.

7. The antenna module according to claim 2,
wherein the first substrate includes a ground layer on a first mounting surface side with respect to the feeding line, and
the ground layer forms the non-interference portion.

8. The antenna module according to claim 3,
wherein the first substrate includes a ground layer on a first mounting surface side with respect to the feeding line, and
the ground layer forms the non-interference portion.

9. The antenna module according to claim 4,
wherein the first substrate includes a ground layer on a first mounting surface side with respect to the feeding line, and
the ground layer forms the non-interference portion.

10. The antenna module according to claim 5,
wherein the first substrate includes a ground layer on a first mounting surface side with respect to the feeding line, and
the ground layer forms the non-interference portion.
